(19) United States
(12) Patent Application Publication
(10) Pub. No.: US 2013/0138820 A1
(43) Pub. Date: May 30, 2013

(54) COMMUNICATION EQUIPMENT THAT PERFORMS COMMUNICATIONS VIA NETWORK, CONTROL METHOD THEREFOR, AND STORAGE MEDIUM

(71) Applicant: Canon Kabushiki Kaisha, Tokyo (JP)

(72) Inventor: Hidenori YOKOKURA, Kawasaki-shi (JP)

(73) Assignee: CANON KABUSHIKI KAISHA, Tokyo (JP)

(21) Appl. No.: 13/679,275

(22) Filed: Nov. 16, 2012

(30) Foreign Application Priority Data
Nov. 25, 2011 (JP) 2011-257455

(51) Int. Cl. H04L 29/06

(52) U.S. Cl. CPC H04L 65/1073
USPC 709/227

(57) ABSTRACT

Communication equipment which is capable of reducing communication time when transmitting a plurality of data using SIP. When a plurality of data are to be transmitted, a connection request message for requesting a plurality of media sessions is transmitted. Upon receiving a connection response message in response to the connection request message, it is determined whether or not the plurality of media sessions have been permitted in the connection request message. When it is determined that the plurality of media sessions have been permitted, the plurality of media sessions are established, and transmit each of the plurality of data is transmitted in each of the media sessions.

### BACKGROUND OF THE INVENTION

1. Field of the Invention

The present invention relates to communication equipment that performs communications via a network, and in particular, to communication equipment that performs communications using SIP (Session Initiation Protocol), a control method therefor, and a computer-readable storage medium storing a control program for implementing the method.

2. Description of the Related Art

In recent years, infrastructures concerning next-generation networks (NGN: Next Generation Networks) have been developed. Accordingly, communication networks have been shifting from analog networks to networks using IP (Internet Protocol). Under such circumstances, for example, IP-FAX which is facsimile communication via IP networks can be performed in the Intranet.

On the other hand, in communications using SIP, data communications that are not limited to IP-FAX can be performed, and development of remote printing, remote maintenance, and so on is expected to be advanced.

Additionally, in communications using SIP, for example, voice and video communications as well as data communications can be performed. For example, some systems can provide concurrent connection control (concurrent session control) of voice through communications using SIP (see, for example, Japanese Unexamined Patent Publication (Kohyo) No. 2008-541501).

SIP is a standard protocol for establishing a session (SIP session) between a plurality of clients. SIP provides session control by performing message communications via a SIP server and obtaining an IP address or a port number of a destination.

Moreover, in communications using SIP, a description language called SDP (Session Description Protocol) is used. Using the SDP, an IP address or a port number of receiving-end communication equipment is posted to transmitting-end communication equipment, and negotiations on media sessions are carried out between them.

It should be noted that a media session means a session in which transmitting-end communication equipment and receiving-end communication equipment transmits media (such as voice, image, and data) in peer-to-peer fashion. In this media session, communications are performed using TCP/IP (Transmission Control Protocol/Internet Protocol) or UDP/IP (User Datagram Protocol/Internet Protocol).

Conventionally, when a plurality of data (for example, images and documents) are to be transmitted to the same receiving-end communication equipment (a plurality of documents are selected from a so-called box), the first document is transmitted first. When the transmission of the first document is completed, the transmission of the next document is started.

In this way, when a plurality of data are to be transmitted to receiving-end communication equipment, a sequential transmission process is carried out. Thus, when a plurality of documents are to be transmitted, communication time increases with increase in the number of documents.

### SUMMARY OF THE INVENTION

The present invention provides communication equipment that is capable of reducing communication time when transmitting a plurality of data using SIP, a control method therefor, and a computer-readable storage medium storing a control program for implementing the method.

Accordingly, a first aspect of the present invention provides communication equipment that transmits data using SIP (Session Initiation Protocol), comprising a connection requesting unit configured to, when transmitting a plurality of data, transmit a connection request message for requesting a plurality of media sessions corresponding in number to the plurality of data, a determination unit configured to, upon receiving a connection response message in response to the connection request message, determine whether the plurality of media sessions have been permitted in the connection request message, and a transmission unit configured to, when the determination unit determines that the plurality of media sessions have been permitted, establish the plurality of media sessions and transmit each of the plurality of data in each of the media sessions.

Accordingly, a second aspect of the present invention provides a control method for communication equipment that transmits data using SIP (Session Initiation Protocol), comprising a connection requesting step of, when transmitting a plurality of data, transmitting a connection request message for requesting a plurality of media sessions corresponding in number to the plurality of data, a determination step of, upon receiving a connection response message in response to the connection request message, determining whether the plurality of media sessions have been permitted in the connection request message, and a transmission step of, when it is determined in the determination step that the plurality of media sessions have been permitted, establishing the plurality of media sessions and transmitting each of the plurality of data in each of the media sessions.

Accordingly, a third aspect of the present invention provides a non-transitory computer-readable storage medium storing a control program for implementing a control method for communication equipment that transmits data using SIP (Session Initiation Protocol), the control method comprising a connection requesting step of, when transmitting a plurality of data, transmitting a connection request message for requesting a plurality of media sessions corresponding in number to the plurality of data, a determination step of, upon receiving a connection response message in response to the connection request message, determining whether the plurality of media sessions have been permitted in the connection request message, and a transmission step of, when it is determined in the determination step that the plurality of media sessions have been permitted, establishing the plurality of media sessions and transmitting each of the plurality of data in each of the media sessions.

According to the present invention, communication time can be reduced when a plurality of data are transmitted using SIP.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of communication equipment according to an embodiment of the present invention.

FIG. 2 is a view showing an exemplary network to which the communication equipment appearing in FIG. 1 is connected.

FIG. 3 is a block diagram schematically showing an exemplary arrangement of internal modules in the communication equipment appearing in FIG. 2.

FIGS. 4A and 4B are views showing control tables concerning transmission of documents registered in the communication equipment appearing in FIG. 2, in which FIG. 4A shows an exemplary control table, and FIG. 4B shows another exemplary control table.

FIG. 5 is a view showing an exemplary user interface (UI) for use in performing SIP communications by the communication equipment appearing in FIG. 2.

FIGS. 6A and 6B are views showing SDPs for use in performing SIP communications by the communication equipment appearing in FIG. 2, in which FIG. 6A shows an exemplary SDP in transmitting-end communication equipment, and FIG. 6B shows an exemplary SDP in receiving-end communication equipment.

FIG. 7 is a sequence diagram useful in explaining an exemplary communication process carried out between the communication equipment appearing in FIG. 2.

FIG. 8 is a sequence diagram useful in explaining another exemplary communication process carried out between the communication equipment appearing in FIG. 2.

FIG. 9 is a flowchart useful in explaining an exemplary transmission process carried out in the communication equipment appearing in FIG. 2.

### DESCRIPTION OF THE EMBODIMENTS

A description will now be given of exemplary communication equipment according to an embodiment of the present invention with reference to the drawings.

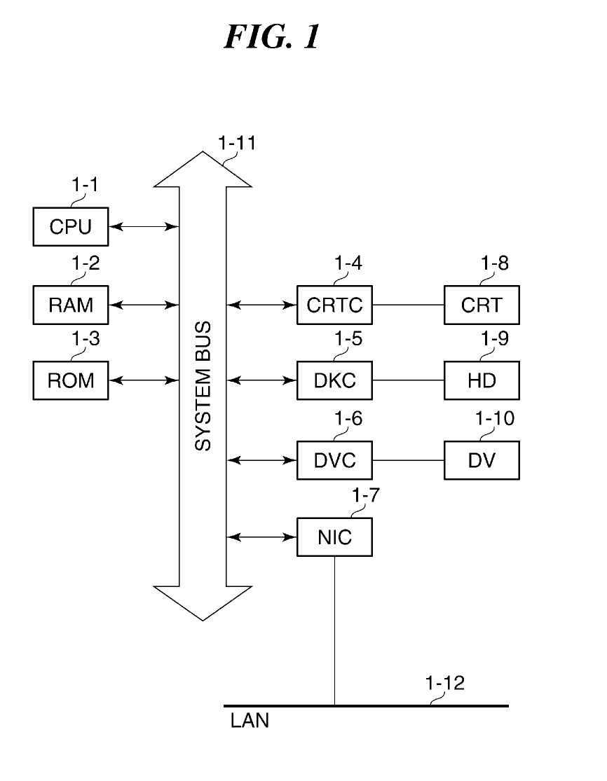

FIG. 1 is a block diagram schematically showing an arrangement of communication equipment according to an embodiment of the present invention.

Referring to FIG. 1, the illustrated communication equipment is, for example, an image forming apparatus such as a printer. The communication equipment has a CPU 1-1, which executes programs stored in a ROM 1-3 to control the overall operation of the communication equipment. A RAM 1-2 is used as a main memory, a work area, and so on for the CPU 1-1. Further, the RAM 1-2 is used as a backup RAM that holds, for example, session information in SIP (Session Initiation Protocol), to be described later.

A CRT controller (CRTC) 1-4 controls display screens on a CRT display (CRT) 1-8. By referring to the CRT display 1-8, a user can configure, for example, IP (Internet Protocol)-FAX settings.

A disk controller (DKC) 1-5 controls a hard disk (HD) 1-9 for storing images and various user data. A device controller (DVC) 1-6 controls a printer unit and a scanner (DV) 1-10.

A network interface card (NIC) 1-7 performs communications via a LAN 1-12 under the control of the CPU 1-1. The CRT 1-8 shown in the figure has a touch panel but may also be equipped with a keyboard. Further, it is not particularly necessary to have the HD 1-9, and a USB memory or the like may be used in place of the HD 1-9. Further, communication port setting values, to be described later, are stored in the backup RAM, but may be stored in the HD 1-9.

It should be noted that as shown in the figure, the CPU 1-1, the RAM 1-2, the ROM 1-3, the CRTC 1-4, the DKC 1-5, the DVC 1-6, and the NIC 1-7 are connected together via a system bus 1-11.

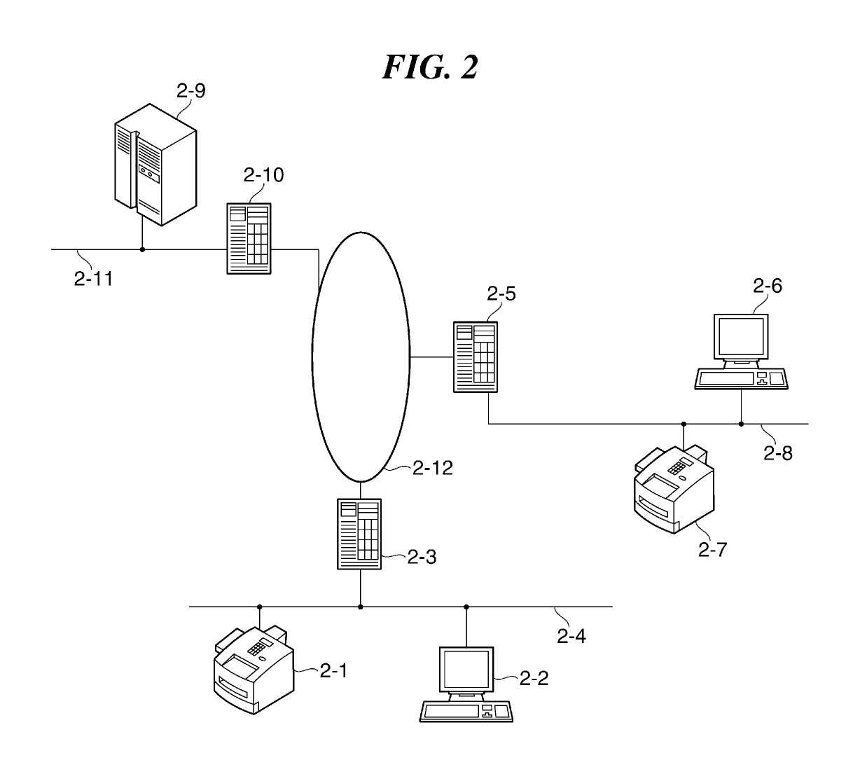

FIG. 2 is a view showing an exemplary network to which the communication equipment appearing in FIG. 1 is connected.

Communication equipment 2-1 and 2-7 shown in the figure each have the same arrangement as that of the communication equipment described with reference to FIG. 1. The communication equipment 2-1 is connected to a LAN (local-area network) 2-4, to which a PC (personal computer) 2-2 is connected. The LAN 2-4 is connected to the Internet (network) 2-12 via a proxy server 2-3 for Internet access.

Likewise, the communication equipment 2-7 is connected to a LAN 2-8, to which a PC 2-6 is connected. The LAN 2-8 is connected to the Internet 2-12 via a proxy server 2-5.

A SIP server 2-9 is connected to a LAN 2-11, which is connected to the Internet 2-12 via a proxy server 2-10.

The PCs 2-2 and 2-6 instruct the communication equipment 2-1 and 2-6, respectively, to carry out processes such as printing and monitor their respective statuses. The SIP server 2-9 controls voice communications such as IP telephone and data communications such as IP-FAX.

As an exemplary network, the Internet 2-12 is used, but any other networks may be used. Further, although in the figure, only the communication equipment 2-1 and 2-7 and the PCs 2-2 and 2-7 are illustrated, the number of communication equipment and the number of PCs are not limited to the example shown in the figure.

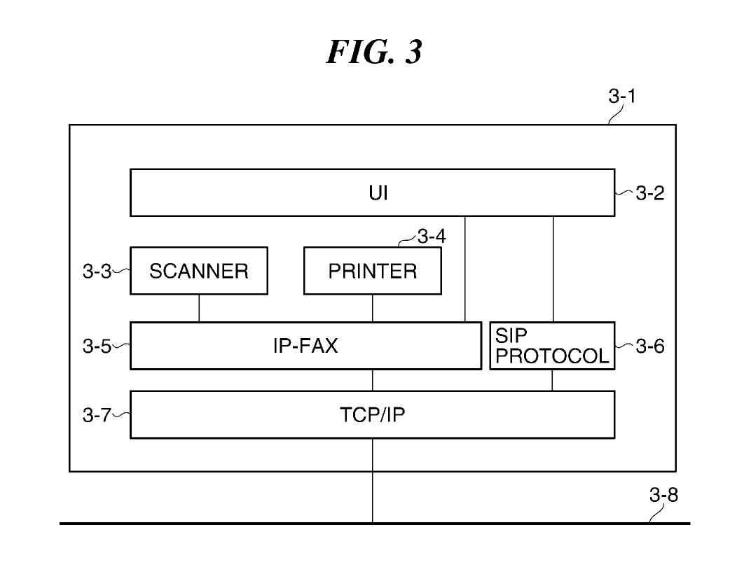

FIG. 3 is a block diagram schematically showing an exemplary arrangement of internal modules in the communication equipment appearing in FIG. 2.

As described earlier, each of the communication erumpent 2-1 and 2-7 is, for example, an image forming apparatus, and the DV 1-10 shown in FIG. 1 is illustrated as a scanner 3-3 and a printer 3-4 in FIG. 3. Further, the communication erumpent 2-1 and 2-7 each have a user interface (UI) module 3-2, an IP-FAX module 3-5, a SIP protocol module 3-6, and a TCP/IP (Transmission Control Protocol/Internet Protocol) module 3-7.

The TCP/IP module 3-7 has a TCP/IP function and a UDP/IP (User Datagram Protocol/Internet Protocol) function and controls transmission and reception of data to and from other communication equipment on the LAN 3-8.

The SIP protocol module 3-6 carries out a SIP session establishing process by transmitting and receiving a SIP packet (also referred to as SIP data) to and from communication equipment, which is present on the LAN 3-8, via the TCP/IP module 3-7.

The IP-FAX module 3-5 transmits and receives IP-FAX to and from other communication equipment, which is present on the LAN 3-8, via the TCP/IP module 3-7.

The UI module 3-2, the IP-FAX module 3-5, the SIP protocol module 3-6, and the TCP/IP module 3-7 operate on the CPU 1-1 or the NIC 1-7 appearing in FIG. 1.

It should be noted that although in FIG. 3, there are the scanner 3-3 and the printer 3-4 because IP-FAX communications are taken as examples, the scanner 3-3 and the printer 3-4 may be dispensed with as long as IP communications other than IP-FAX are performed.

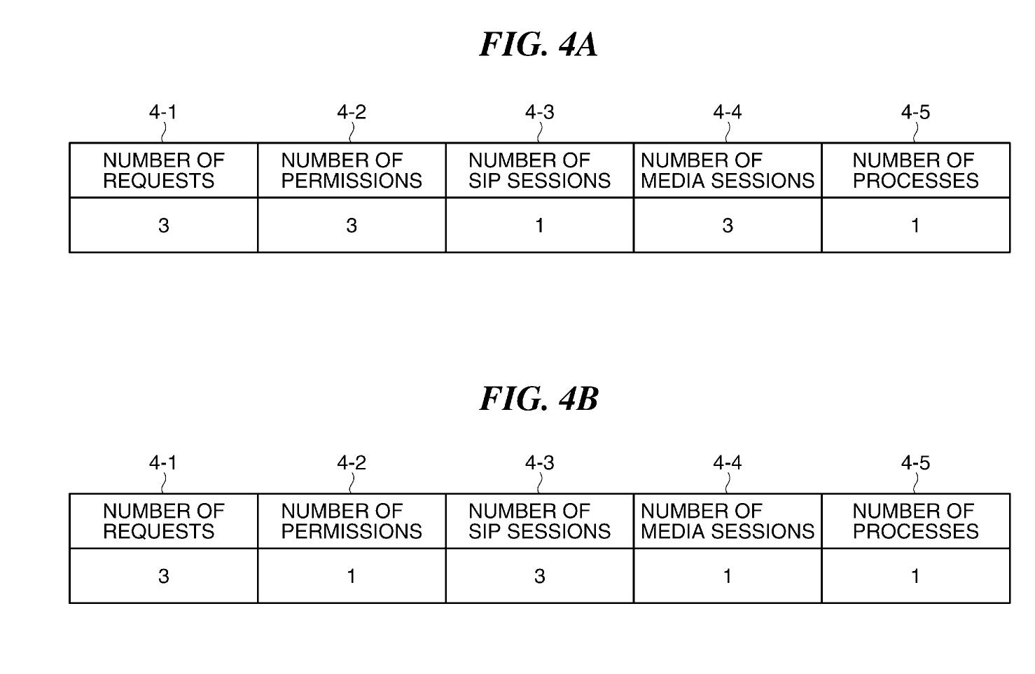

FIGS. 4A and 4B are views showing control tables relating to transmission of documents registered in the communication equipment appearing in FIG. 2. FIG. 4A shows an exemplary control table, and FIG. 4B shows another exemplary control table.

The control tables shown in the figures are stored in, for example, the RAM 1-2 appearing in FIG. 1. Referring to FIGS. 4A and 4B, the control tables have a data region 4-1 in which the number of requests to transmit documents (that is, the number of documents that should be transmitted) is stored, and here, the number of requests is equal to three in both FIG. 4A and FIG. 4B.

The control tables have a data region 4-2 in which a permissible number is managed. The permissible number of receiving-end communication equipment obtained by negotiation with receiving-end communication equipment is stored. In FIG. 4A, the permissible number is three, which is equal to the number of requests, and a plurality of media sessions can be established. On the other hand, in FIG. 4B, the permissible number is one, and one media session is permitted.

The control tables have a data region 4-3 in which the number of SIP sessions with receiving-end communication equipment is managed. In FIG. 4A, because a plurality of media sessions can be established, the number of SIP sessions is one. In FIG. 4B, because the number of media sessions (that is, the permissible number of media sessions) is “one”, SIP sessions corresponding in number to the number of documents (that is, the number of requests: the number of data) are required, and hence the number of SIP sessions is three.

The control tables have a data region 4-4 in which the number of media sessions with receiving-end communication equipment is managed. In FIG. 4A, because media sessions corresponding in number to the number of documents (the number of data) can be established as described earlier, the number of media sessions is three. On the other hand, in FIG. 4B, because a plurality of media sessions cannot be established, the number of media sessions is one.

The control tables have a data region 4-5 in which the number of documents subjected to a transmission process is managed as the number of processes. In both FIG. 4A and FIG. 4B, the number of processes is one, and this indicates that a transmission process on one document has been completed. The number of processes comes to be “three” at the end.

Although in the examples shown in FIG. 4A and FIG. 4B, the number of requests is three, the number of requests is not limited to “three” as long as a plurality of documents are transmitted. Further, data to be transmitted is not limited to documents, but for example, the number of copies to be made in printing of multiple copies in remote printing or the number of process batches in concurrent processing in remote maintenance may be managed as the number of requests.

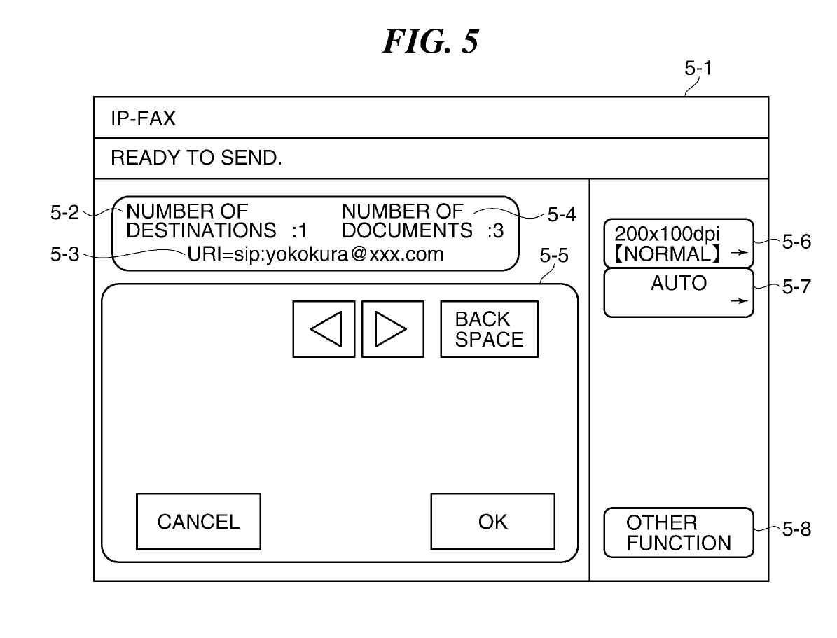

FIG. 5 is a view showing an exemplary user interface (UI) for use in SIP communications by the communication equipment appearing in FIG. 2. It should be noted that the UI shown in the figure is displayed on, for example, the CRT 1-8 appearing in FIG. 1.

A user inputs an instruction to transmit documents by IP-FAX using SIP. On this occasion, the user inputs a destination and selects documents that should be transmitted. As a result, the UI module 3-2 displays a UI screen 5-1 on the CRT 1-8. The number of destinations 5-2, a destination (SIP-URI) 5-3, and the number of documents that should be transmitted 5-4 are displayed on the UI screen 5-1. In the example shown in the figure, the number of destinations is one, and the number of documents is three.

Further, a UI button 5-5 is displayed on the UI screen 5-1. The user can edit the SIP-URI using this UI button 5-5 and further select whether to do transmission (OK) or cancel the transmission.

A resolution selection button 5-6, an original sheet size selection button 5-7, and other-function button (advanced setting button) 5-8 are displayed on the UI screen 5-1. The resolution selection button 5-6 is a button for selecting the resolution of documents, and in the example shown in the figure, a resolution of 200×100 dpi is selected.

The original sheet size selection button 5-7 is a button for selecting the size of documents that should be transmitted, and here, auto is selected as an original sheet size. The user can set the density of documents that should be transmitted, the type of originals, double-sided originals, and mixed original size, and so on using the advanced setting button 5-8.

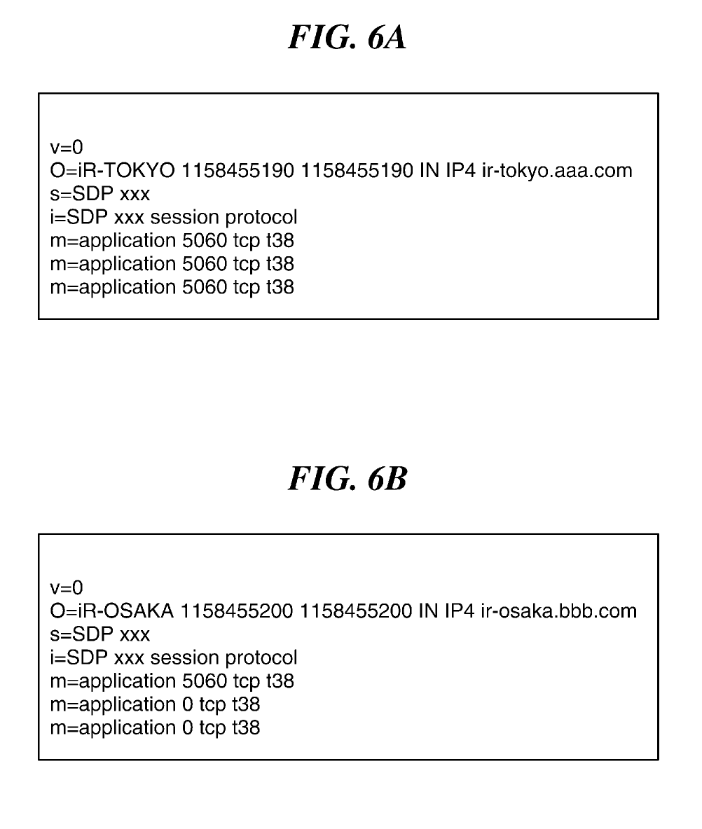

FIGS. 6A and 6B are views showing SDPs for use in SIP communications by the communication equipment appearing in FIG. 2. FIG. 6A shows an exemplary SDP in transmitting-end communication equipment, and FIG. 6B shows an exemplary SDP in receiving-end communication equipment.

In FIG. 6A, “v” denotes a type that indicates the version of a protocol. Here, v is zero because a version 0 of SDP is used. “O” denotes a type that indicates information for identifying a session, and here, identification information on a device (communication equipment) that has started a session. “s” denotes a type that indicates a session name, and “i” denotes a type that indicates session information.

“m” denotes a type that indicates a media type, a transport address, and an application name. Here, a media type is declared with “application”, “port 5060”, “TCP connection”, and “application: t38”. As described with reference to FIGS. 4A and 4B, three m declarations are described in parallel for a case where the number of documents is three.

In FIG. 6B as well, similar descriptions are given, but here, because the number of media sessions is set at one, a permission is given with a port 5060 being designated in one of m. In the rest two of m, no permission is given with a port 0 being designated. As a result, when transmitting-end communication equipment issues requests to establish three media sessions, receiving-end communication negotiates to permit one media session.

It should be noted that although here, the number of media sessions required to be established is three, the number of media sessions required to be established is not limited to three. Moreover, in FIG. 6B, if a port 0 is not designated for the rest two of m, three media sessions will be permitted as requested.

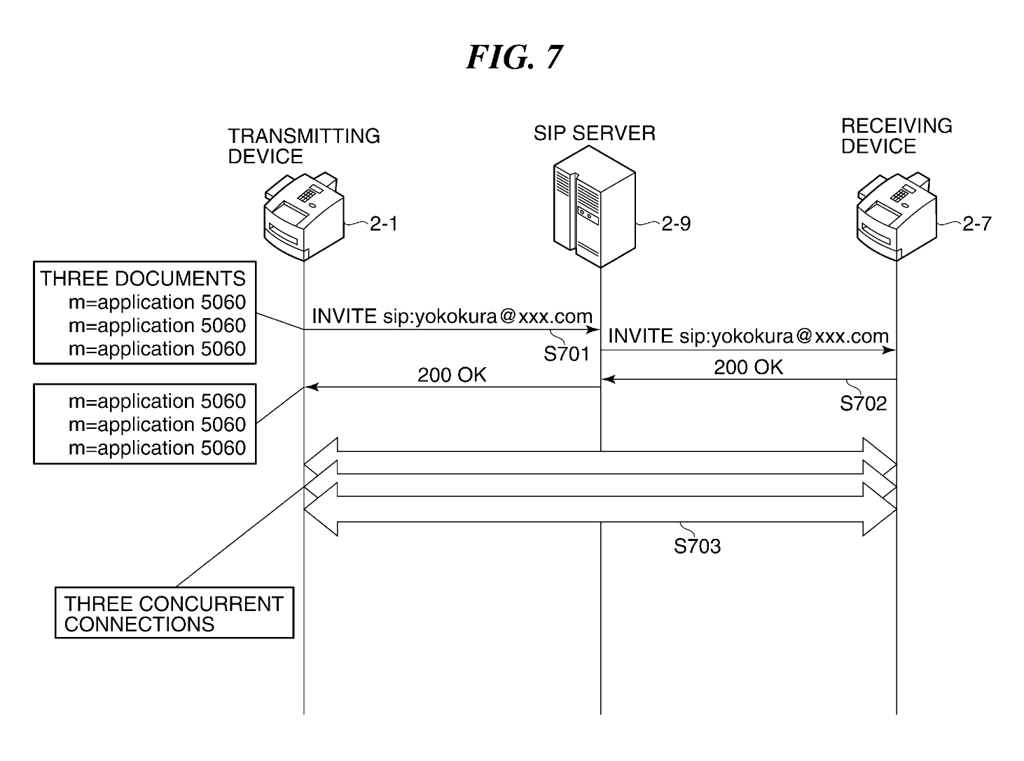

FIG. 7 is a sequence diagram useful in explaining an exemplary communication process carried out between the communication equipment appearing in FIG. 2. In FIG. 7, it is assumed that the communication equipment 2-1 is a transmitting device, and the communication equipment 2-7 is a receiving device, and a description will be given of SIP communications in a case where a plurality of media sessions have been established. It should be noted that in FIG. 7, component elements other than the transmitting device 2-1, the receiving device 2-7, and the SIP server 2-9 are omitted for the convenience of explanation.

As described with reference to FIG. 5, a transmitting instruction is issued by operating the UI button 5-5 on the UI screen 5-1 in the transmitting device 2-1. In response to this, the UI module 3-2 instructs the SIP module 3-6 to carry out a SIP session establishing process. In the example shown in the figure, the SIP module 3-6 generates a SIP connection request message (INVITE), sets a SIP address (SIP URI) “sip: yokokura@xxx.com” as a destination, and also, as described earlier, sets a transmitting-end SDP. Here, because there is a request to transmit three documents to the same destination (see FIG. 5), the SIP module 3-7 requests three media sessions using the transmitting-end SDP (see FIG. 6A).

Then, the SIP module 3-6 transmits the SIP connection request message (INVITE) to the SIP server 2-9 via the TCP/IP module 3-7 (S701). Upon receiving the SIP connection request message, the SIP server 2-9 transmits the SIP connection request message to a SIP URI (destination) set in the SIP connection request message. Here, the SIP server 2-9 transmits the SIP connection request message to the receiving device 2-7.

In response to the SIP connection request message, the receiving device 2-7 transmits a response message (200 OK) to the SIP server 2-9 (S702). Upon receiving the response message from the receiving device 2-7, the SIP server 2-9 generates a connection response message (200 OK) and sends this connection response message to the transmitting device 2-1. As a result, a SIP session is established. Here, the receiving device 2-7 gives a permission to establish connections by three media sessions using a receiving-end SDP.

In the transmitting device 2-1, the SIP module 3-6 establishes connections by three media sessions at the same time via the TCP/IP module 3-7 in response to the permission described by the receiving-end SDP. Then, the IP-FAX module 3-5 transmits one document by each media session using IP-FAX via the TCP/IP module 3-7. As a result, by one SIP session, different three documents are transmitted using IP-FAX at the same time from the transmitting device 2-1 to the receiving device 2-7.

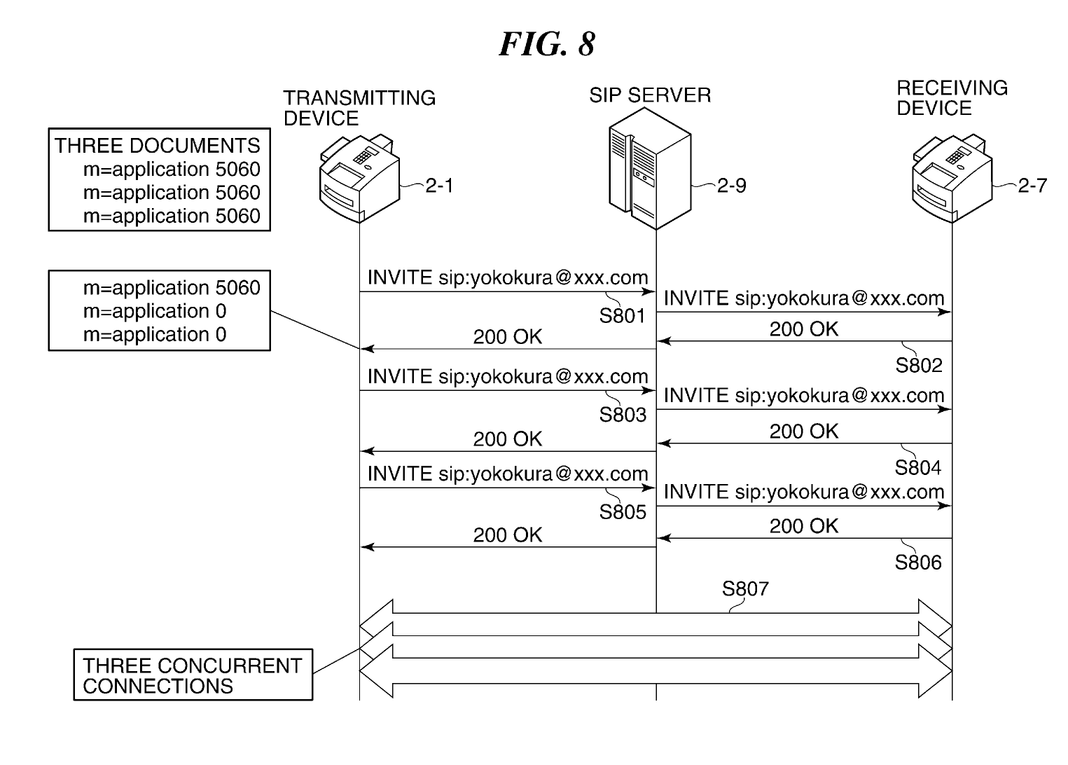

FIG. 8 is a sequence diagram useful in explaining another exemplary communication process carried out between the communication equipment appearing in FIG. 2.

In FIG. 8, it is assumed that the communication equipment 2-1 is a transmitting device, and the communication equipment 2-7 is a receiving device, and component elements other than the transmitting device 2-1, the receiving device 2-7, and the SIP server 2-9 are omitted for the convenience of explanation.

As described with reference to FIG. 5, a transmitting instruction is issued by operating the UI button 5-5 on the UI screen 501 in the transmitting device 2-1. In response to this, the UI module 3-2 instructs the SIP module 3-6 to carry out a SIP session establishing process. In the example shown in the figure, the SIP module 3-6 generates a SIP connection request message (INVITE), sets a SIP address (SIP URI) “sip: yokokura@xxx.com” as a destination, and also, as described earlier, sets a transmitting-end SDP. Here, because there is a request to transmit three documents to the same destination (see FIG. 5), the SIP module 3-7 requests three media sessions using the transmitting-end SDP.

Then, the SIP module 3-6 transmits the SIP connection request message (INVITE) to the SIP server 2-9 via the TCP/IP module 3-7 (S801). Upon receiving the SIP connection request message, the SIP server 2-9 transmits the SIP connection request message to a SIP URI (destination) set in the SIP connection request message. Here, the SIP server 2-9 transmits the SIP connection request message to the receiving device 2-7.

In response to the SIP connection request message, the receiving device 2-7 transmits a response message (200 OK) to the SIP server 2-9 (S802). Upon receiving the response message from the receiving device 2-7, the SIP server 2-9 generates a connection response message (200 OK) and sends this connection response message to the transmitting device 2-1. As a result, a SIP session is established. Here, the receiving device 2-7 gives a permission to establish a connection by one media session.

Because the permission to establish a connection by one media session is given, the transmitting device 2-1 sends a SIP connection request message (INVITE), in which a sip address “sip:yokokura@xxx.com ” is set, to the SIP server 2-9 (S803). Upon receiving the SIP connection request message, the SIP server 2-9 transmits a SIP connection request message to a SIP URI (destination) set in the SIP connection request message.

In response to the SIP connection request message, the receiving device 2-7 transmits a response message (200 OK) to the SIP server 2-9 (S804). Upon receiving the response message from the receiving device 2-7, the SIP server 2-9 generates a connection response message (200 OK) and sends this connection response message to the transmitting device 2-1. As a result, a SIP session is established. Here, the receiving device 2-7 gives a permission to establish a connection by one media session.

Because it is necessary for the transmitting device 2-1 to transmit three documents by IP-FAX, the SIP module 3-6 sends again a SIP connection request message (INVITE), in which a sip address “sip:yokokura@xxx.com ” is set, to the SIP server 2-9 via TCP/IP module 3-7 (S805). Then, upon receiving the SIP connection request message, the SIP server 2-9 transmits a SIP connection request message to a SIP URI (destination) set in the SIP connection request message.

In response to the SIP connection request message, the receiving device 2-7 transmits a response message (200 OK) to the SIP server 2-9 (S806). Upon receiving the response message from the receiving device 2-7, the SIP server 2-9 generates a connection response message (200 OK) and sends this connection response message to the transmitting device 2-1. As a result, a SIP session is established. Here, the receiving device 2-7 gives a permission to establish a connection by one media session using a receiving-end SDP.

In the above described way, after three media sessions are permitted by establishing three SIP sessions, the IP-FAX module 3-5 transmits one document by IP-FAX in each media session via the TCP/IP module 3-7.

As a result, by three SIP sessions, different three documents are transmitted using IP-FAX at the same time from the transmitting device 2-1 to the receiving device 2-7. Namely, when establishment of media sessions corresponding in number to a plurality of documents is not permitted, a SIP session and a media session are established for transmission of each document.

Although in the example shown in FIG. 8, a media session is established after three SIP sessions are established, it may be arranged such that when one SIP session is established, the corresponding media session is established.

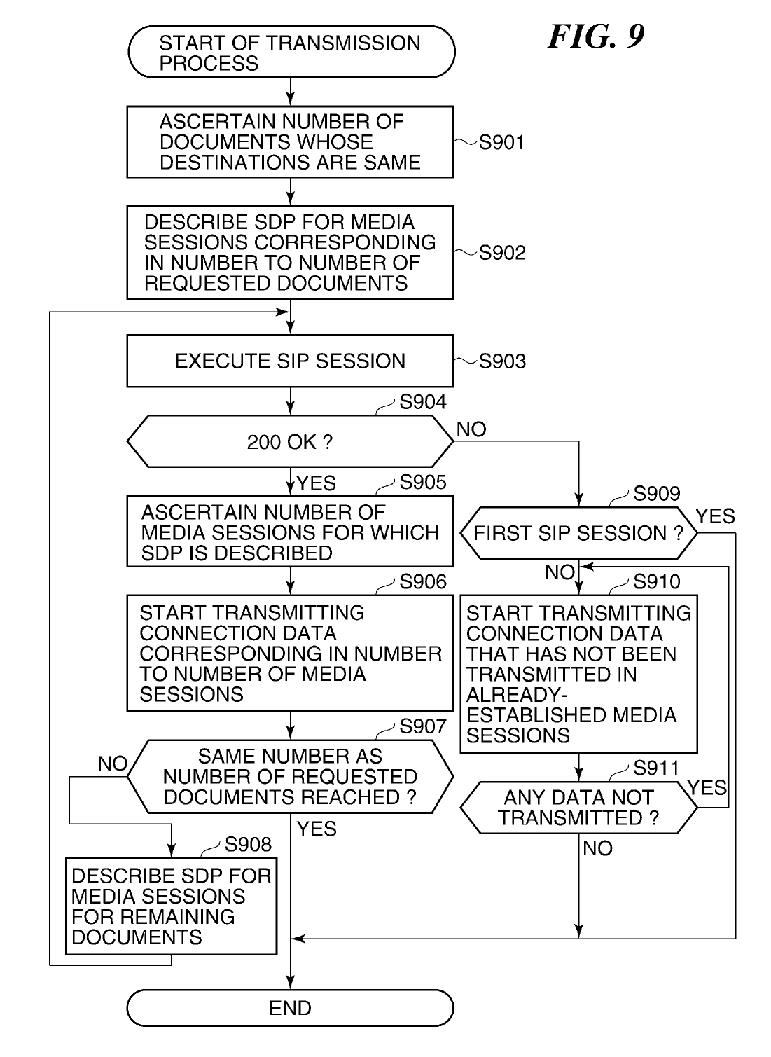

FIG. 9 is a flowchart useful in explaining an exemplary transmission process carried out in the communication equipment appearing in FIG. 2.

Referring to FIGS. 1 and 9, when there is an instruction to perform IP-FAX transmission, the CPU 1-1 ascertains the number of documents whose destinations are the same selected in the instruction (step S901). The CPU 1-1 then describes SDP that indicates media sessions corresponding in number to the number of requested documents (step S902). When the number of requested documents is three, a description in SDP is given as described above with reference to FIG. 6A. On the other hand, when the number of requested documents is one, a description in SDP is given for one m in FIG. 6A.

Next, the CPU 1-1 establishes a SIP session using the description in SDP (step S903). The CPU 1-1 then determines whether or not a connection response message (200 OK) has been sent back from the receiving-end device (step S904).

When the connection response message (200 OK) has been sent back from the receiving-end device (YES in the step S904), the CPU 1-1 analyzes the receiving-end SDP description included in the connection request message and ascertains the number of permitted media sessions (step S905). Then, the CPU 1-1 establishes sessions corresponding in number to the number of permitted media sessions and starts transmitting documents (that is, data) (step S906).

Next, the CPU 1-1 determines whether or not the number of requested documents and the number of transmitted documents have become equal (step S907). When the number of requested documents and the number of transmitted documents have not become equal, that is, when the number of requested documents is greater than the number of transmitted documents (NO in the step S907), the CPU 1-1 describes in SDP the permissible number of media sessions with respect to documents that have not yet been transmitted (data that has not yet been transmitted), and returns to the process in the step S903.

For example, assume that two media sessions are permitted with respect to four documents. In this case, media sessions that can be permitted for two documents that have not yet been transmitted (data that has not yet been transmitted) is described in SDP. Also, when three media sessions are permitted for five documents, media sessions that can be permitted for two documents that have not yet been transmitted (data that has not yet been transmitted) is described in SDP.

When the number of requested documents and the number of transmitted documents are equal (YES in the step S907), the CPU 1-1 terminates the transmission process.

When no connection response message (200 OK) has not been sent back from the receiving-end device (NO in the step S904), that is, when a connection rejection message has been sent back, the CPU 1-1 determines whether or not the connection rejection message from the receiving-end device is one relating to a SIP session of which establishment was attempted first (first SIP session) (step S909). When the connection reject message is one relating to the first SIP session (YES in the step S909), the CPU 1-1 terminates the transmission process.

On the other hand, when the connection rejection message is not one relating to the first SIP session (NO in the step S909), the CPU 1-1 starts transmitting documents, which have not yet been transmitted, using already-established media sessions (step S910). Then, the CPU 1-1 determines whether or not there is any document that has not yet been transmitted (step S911). It should be noted that the determination in the step S911 may be carried out after the transmission of the documents started in the step S910 has been completed, or may be carried out in parallel with the transmission of the documents started in the step 5911 (before the transmission of the documents is completed).

When there is any document that has not yet been transmitted (YES in the step S911), the CPU 1-1 returns to the process in the step S910. On the other hand, when there is no document that has not yet been transmitted (NO in the step S911), the CPU 1-1 terminates the transmission process.

In the above described example shown in FIG. 9, IP FAX transmission is performed, but for example, this can be applied even to a case where a plurality of copies are made in remote printing or a case where data is transmitted in remote maintenance or the like. Moreover, in the step S908, after the second SIP session is established, it is possible to fix to a description in a media session in one document.

As described above, according to the embodiment of the present invention, communication time can be reduced when a plurality of data are transmitted, and thus SIP data communications can be speeded up by optimum sequences.

As is apparent from the above description, in the example shown in FIG. 1, the CPU 1-1 and the NIC 1-12 act as a connection request unit and a transmission unit. The CPU 1-1 also acts as a determination unit.

Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-257455 filed Nov. 25, 2011, which is hereby incorporated by reference herein in its entirety.

What is claimed is:

1. Communication equipment that transmits data using SIP (Session Initiation Protocol), comprising:
a connection requesting unit configured to, when transmitting a plurality of data, transmit a connection request message for requesting a plurality of media sessions corresponding in number to the plurality of data;
a determination unit configured to, upon receiving a connection response message in response to the connection request message, determine whether the plurality of media sessions have been permitted in the connection request message; and
a transmission unit configured to, when said determination unit determines that the plurality of media sessions have been permitted, establish the plurality of media sessions and transmit each of the plurality of data in each of the media sessions.

2. Communication equipment according to claim 1, wherein when said determination unit determines that the plurality of media sessions have not been permitted, said transmission unit establishes one media session for transmission of each of the plurality of data.

3. Communication equipment according to claim 2, wherein when said determination unit determines that the plurality of media sessions have not been permitted, said transmission unit establishes one media session in one SIP session.

4. Communication equipment according to claim 1, wherein when said determination unit determines that the plurality of media sessions have been permitted, said transmission unit establishes a plurality of media sessions in one SIP session.

5. A control method for communication equipment that transmits data using SIP (Session Initiation Protocol), comprising:
a connection requesting step of, when transmitting a plurality of data, transmitting a connection request message for requesting a plurality of media sessions corresponding in number to the plurality of data;
a determination step of, upon receiving a connection response message in response to the connection request message, determining whether the plurality of media sessions have been permitted in the connection request message; and
a transmission step of, when it is determined in said determination step that the plurality of media sessions have been permitted, establishing the plurality of media sessions and transmitting each of the plurality of data in each of the media sessions.

6. A control method according to claim 5, wherein when it is determined in said determination step that the plurality of media sessions have not been permitted, one media session for transmission of each of the plurality of data is established in said transmission step.

7. A control method according to claim 5, wherein when it is determined in said determination step that the plurality of media sessions have not been permitted, one media session in one SIP session is established in said transmission step.

8. A control method according to claim 5, wherein it is determined in said determination step that the plurality of media sessions have been permitted, a plurality of media sessions in one SIP are established in said transmission step.

9. A non-transitory computer-readable storage medium storing a control program for implementing a control method for communication equipment that transmits data using SIP (Session Initiation Protocol), the control method comprising:
a connection requesting step of, when transmitting a plurality of data, transmitting a connection request message for requesting a plurality of media sessions corresponding in number to the plurality of data;
a determination step of, upon receiving a connection response message in response to the connection request message, determining whether the plurality of media sessions have been permitted in the connection request message; and
a transmission step of, when it is determined in the determination step that the plurality of media sessions have been permitted, establishing the plurality of media sessions and transmitting each of the plurality of data in each of the media sessions.
